(19) United States
(12) Patent Application Publication
(10) Pub. No.: US 2019/0337528 A1
(43) Pub. Date: Nov. 7, 2019

(54) Operating Device for a Motor Vehicle and Method for Operating an Operating Device

(71) Applicant: Bayerische Motoren Werke Aktiengesellschaft, Muenchen (DE)

(72) Inventors: Klaus BAUMER, Muenchen (DE); Thomas CHRIST, Muenchen (DE)

(21) Appl. No.: 16/509,664

(22) Filed: Jul. 12, 2019

Related U.S. Application Data
(63) Continuation of application No. PCT/EP2018/051918, filed on Jan. 26, 2018.

(30) Foreign Application Priority Data
Feb. 9, 2017 (DE) 10 2017 202 051.2

(51) Int. Cl. B60W 50/08; B60W 50/14; G06F 3/041

(52) U.S. Cl. CPC B60W 50/082; B60W 50/14; B60W 2040/0809; B60W 2050/146; G06F 3/041

(57) ABSTRACT

An operating device for a motor vehicle having a driving mode and a stationary mode includes an operating part, by which an operating process can be executed for a communication device, and a control device coupled to the operating part. The control device is designed to provide the driver of the motor vehicle with a first selection of operating options for the communication device in the stationary mode and a second selection of operating options for the communication device in the driving mode. The operating options of the second selection are chosen according to the degree of automation of the driving mode.

### CROSS REFERENCE TO RELATED APPLICATIONS

This application is a continuation of PCT International Application No. PCT/EP2018/051918, filed Jan. 26, 2018, which claims priority under 35 U.S.C. § 119 from German Patent Application No. 10 2017 202 051.2, filed Feb. 9, 2017, the entire disclosures of which are herein expressly incorporated by reference.

### BACKGROUND AND SUMMARY OF THE INVENTION

The invention relates to an operator control device for a motor vehicle and to a method for operating an operator control device.

Such an operator control device serves to control various vehicle functions and is installed, for example, in the applicant's vehicles known by the designation iDrive. The operator control device is described in terms of its method of functioning in DE 38 26 555 A, for example. In modern vehicles, the number of vehicle functions is now in the 3 to 4 digit range-from making available information to activating driver assistance systems, as far as to providing entertainment offers.

The prior art (e.g. DE 10 2009 018 678 A1 or DE 10 2009 018 682 A1) discloses that such an operator control device is configured in such a way that a number of vehicle functions, such as for example entertainment offers, are disabled during driving, i.e. these vehicle functions cannot be actuated. Making available only a limited number of vehicle functions during driving ensures that the driver is not unnecessarily distracted and can concentrate on the road traffic.

However, during automated or autonomous driving, it is desirable that the driver does not have to concentrate on the road traffic, at least for a certain time period, but rather can dedicate himself to other activities. In this case, it is convenient if only a limited number of vehicle functions can be actuated.

The invention is therefore based on the object of easily providing the precondition to allow for the different objectives and/or information requirements during various driving situations.

A first aspect of the invention relates to an operator control device for a motor vehicle having a driving mode and a stationary mode, which operator control device has an operator control part by which an operator control process can be carried out for a communication device, and a control device which is coupled to the operator control part and is designed to provide at least the driver of the motor vehicle (also referred to below as just a vehicle) with a first selection of operator control options for the communication device in the stationary mode, and with a second selection of operator control options for the communication device in the driving mode, wherein the operator control options of the second selection are selected as a function of the degree of automation of the driving mode.

Such an operator control device serves to control various vehicle functions. The vehicle functions comprise functions which relate to the driving functions of the motor vehicle, such as for example the engine control, the transmission control or assistance systems, as well as functions which relate to the making available of information, entertainment contents, communication possibilities and/or navigation services.

A driving mode of the motor vehicle is to be understood as meaning the status of the motor vehicle in which the motor vehicle is moving. The movement can be implemented here by means of a drive or by means of the geographic conditions (e.g. rolling movement owing to a steep slope). A stationary mode of the motor vehicle is to be understood as meaning the status of the motor vehicle in which no movement is carried out, i.e. the vehicle is stationary.

An operator control process for a communication device is to be understood as meaning inputting and/or interrogation for a communication device. The communication device therefore forms the interface for the vehicle function, which is controlled by means of the operator control process. The communication device can be embodied, for example, as a control unit or as a display device or as a combined control and display unit. The communication device can be embodied as a component of the operator control unit or as an external unit. A screen typically serves as an optical monitoring and display device for the operator control process of the communication device.

The operator control part constitutes a control element by which the operator control process can be carried out for the communication device. The motor control part comprises, for example, haptic operator control elements (switches, rotary actuators, push and turn actuators, sliding controllers, trackballs, joysticks, touchpads, touchscreens, etc.), acoustic sensing units and/or evaluation units (microphone, speech recognition system, frequency analyzer etc.) gaze tracking devices (for example camera based), contactless position determining units, 3D position determining units, proximity sensors, driver/front seat passenger recognition systems and/or gesture recognition devices.

For example, the operator control part is embodied as a push switch and/or rotary switch or as a touch input display. The operator control part is preferably arranged in the common reach of the driver and front seat passenger, and optionally in the reach of a passenger on one of the rear seats in the motor vehicle.

The control device which is coupled to the operator control part is designed to provide a passenger or the driver of the motor vehicle, but at least the driver of the motor vehicle, with the selection, i.e. that is to say a specific number, of operator control options. Within the scope of the present embodiments, a passenger of the motor vehicle is understood to be an occupant of the motor vehicle apart from the driver. A passenger of the motor vehicle can therefore be, for example, the front seat passenger or a passenger on one of the seats in the rear part of the motor vehicle. As a rule, the term driver refers to the person who is driving the motor vehicle. This means the person who operates the steering, the drive and/or the brakes. In an automated or fully autonomous driving mode, the driver refers to the person who would usually function as the driver of the vehicle, that is to say for example would sit behind the steering wheel, in a non-automated/non-autonomous motor vehicle. Therefore, a person who does not operate the steering, the drive or the brake owing to an automated or fully autonomous driving mode can also be referred to as a driver of the motor vehicle. An operator control option is to be understood as the option of carrying out an operator control process for the communication device. Such an operator control process can be carried out, for example, by means of a hand or some other body part of a passenger or of the driver of the motor vehicle. If a passenger or the driver activates, for example, a pushbutton switch, this is referred to as an operator control process.

The selection of operator control options which are provided depends on the degree of automation of the driving mode. The term degree of automation is understood to refer to the degree of automation of the automated driving process. The term “automated driving” can be understood to refer to driving with automated longitudinal guidance or transverse guidance or autonomous driving with automated longitudinal and transverse guidance. The term “automated driving” comprises automated driving with any desired degree of automation, in particular assisted, partially automated, highly automated, fully automated or driverless driving. In the case of assisted driving, the driver continuously carries out the longitudinal guidance or transverse guidance while the system performs the respective other function. In the case of partially automated driving, the system performs the longitudinal guidance and transverse guidance, while the driver must continuously operate the system. In the case of highly automated driving, the system performs the longitudinal guidance and transverse guidance without the driver having to continuously monitor the system; the driver must, however, be capable of assuming control of the vehicle within a certain time. In the case of fully automated driving, the system can automatically control the driving in all situations for a specific application situation; for this application situation a driver is no longer necessary. In the case of driverless driving, the system can automatically deal with all situations during the entire journey; a driver is generally no longer necessary.

As a result of the fact that the operator control options are provided at least for the driver of the motor vehicle as a function of the degree of automation, the driver and possibly the passengers are provided with a certain number of operator control options which allow for the respective driving mode situation or stationary mode situation. This ensures that the driver is, on the one hand, not unnecessarily distracted from his actual task, such as for example the driving activity, and, on the other hand, is provided with access to the options relating to information, communication, navigation or the like which are adapted to the respective driving situation.

According to one embodiment of the operator control device according to the invention, the number of operator control options of the second selection is larger the higher the degree of automation of the driving mode. This means, for example, that during fully automated driving more operator control options are made available at least to the driver than during partially automated driving. A specific example of this is access to texts which can be read during driving in the display of the infotainment system or on the head-up display. While in partially automated driving the driver must continuously monitor the system and therefore, from a legal point of view, must not read texts from a display during the driving mode, it is entirely permissible for the driver to read a text from the display in the fully automated driving mode because the system automatically deals with the driving in all situations for a specific use situation, and the driver does not have to perform any monitoring function for this purpose.

According to a further embodiment, in a fully automated or driverless driving mode the second selection comprises all the operator control options of the first selection. This means, for example, that during fully automated or driverless driving, all the operator control options are made available at least to the driver which are provided to him otherwise only during the stationary mode. A typical example of this is the Bluetooth coupling of a mobile radio device. While it is possible to couple a mobile radio device to the infotainment system at any time in the stationary mode, in most vehicles this function is disabled in the driving mode. However, if the vehicle is in the fully automated or driverless driving mode, it is possible to couple a mobile radio device to the infotainment system by means of a Bluetooth connection.

According to a further embodiment, the operator control part is assigned a proximity sensor system by means of which access of the driver or of a passenger to the operator control part can be sensed. The control device is also designed to provide the driver and the passenger with different operator control options in the second selection as a function of access of the driver or passenger which is sensed by the proximity sensor.

By means of the proximity sensor system it is possible to detect whether the driver or the passenger accesses the operator control part. If the access is, for example, by the driver, the operator control of the communication device can be disabled if a legal requirement or a hazard potential from the point of view of the vehicle manufacturer does not permit this access. At the same time, the operator control option of the communication device which is intentionally prohibited can be signaled visually and/or acoustically.

The proximity sensor is preferably oriented in such a way that it can sense both access of the driver and access of a passenger, e.g. of the front seat passenger. In this way, accesses of the driver and passenger can be clearly differentiated. In addition, an increase in reliability is obtained if the proximity sensor is arranged in the region of the operator control part. If the operator control part is a push and turn switch which is arranged on the center console of the vehicle, the proximity sensor system can also be arranged on the center console and on the connecting line between the push and turn switch and the driver and/or front seat passenger/passenger seat. If the operator control part is a screen which is embodied as a touchpad in the dashboard, the proximity sensor system can be arranged on one side or on both sides of the screen. The proximity sensor system can also be configured in the form of an interior camera with immediate evaluation means connected downstream.

Depending on whether the proximity sensor system senses access of the driver or of the passenger, the driver and the passenger are provided with different operator control options within the second selection. Therefore, for example only the operator control options which are legally permissible for the respective traffic situation for the driver or the passenger are made available. If, for example, access of the driver during a non-automated or non-autonomous driving mode is detected, the operator control of the communication device can be disabled, i.e. the number of operator control options is highly restricted. For example, calling detailed information relating to POIs (POI=point of interest) or the selection of telephone numbers for access by the driver are disabled. However, if access by the front seat passenger during an non-automated or non-autonomous driving mode is detected, the operator control of the communication device is not disabled and the number of operator control options is expanded. That is to say therefore that the calling of detailed information relating to POIs or the selection of telephone numbers for access by the front seat passenger are enabled.

The second selection of the operator control options is therefore divided according to this embodiment into operator control options for the driver and into operator control options for the passenger, preferably the front seat passenger.

According to one embodiment, the number of operator control options for the driver rises as the degree of automation of the driving mode increases. This means, for example, that operator control options (such as for example the Bluetooth coupling of a mobile radio device or the calling of detailed information or the typing of messages) which are not provided to the driver, or are disabled, in a non-automated or non-autonomous driving mode, are provided in an automated or autonomous driving mode.

If a fully automated or driverless driving mode is present, according to a further embodiment the operator control options for the driver are equal to the operator control options for the passenger. This means therefore that the driver can access operator control options to the same extent as is possible for a passenger of the vehicle even during non-automated or non-autonomous driving.

According to a further embodiment, sensed access of the driver or of the passenger is checked for its plausibility in that the proximity sensor system is assigned a sensing unit which is designed to check the sensed access for its plausibility. The sensing unit comprises for this purpose a seat sensor which is arranged in or on the driver's seat and/or in or on the passenger's seat. Such a seat sensor can be embodied, for example, as a seat occupation mat. Furthermore, or alternatively, the sensing unit comprises a seat belt lock sensor which is arranged in or on the driver's seat and/or in or on the passenger's seat and is designed to check whether the end piece of the belt lock of the driver and/or the end piece of the belt lock of the passenger is located in the belt lock.

A second aspect of the invention relates to a method for operating an operator control device, described above, for a motor vehicle having a driving mode and a stationary mode, comprising a determining process of a degree of automation of the driving mode, and a provision process in which at least the driver of the motor vehicle is provided with a first selection of operator control options for the communication device in the stationary mode, and a second selection of operator control options for the communication device in the driving mode, wherein the operator control options of the second selection are selected as a function of the degree of automation of the driving mode.

The above statements relating to the inventive operator control device according to the first aspect of the invention also apply correspondingly to the method, described above, for operating an operator control device according to the second aspect. Advantageous exemplary embodiments of the method for operating an operator control device which are not explicitly described at this point correspond to the advantageous exemplary embodiments of the inventive operator control device which are described above or are described in the patent claims.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic block diagram of an operator control device according to one embodiment.

FIG. 2 is a schematic block diagram of an operator control device according to a further embodiment.

### DETAILED DESCRIPTION OF THE DRAWINGS

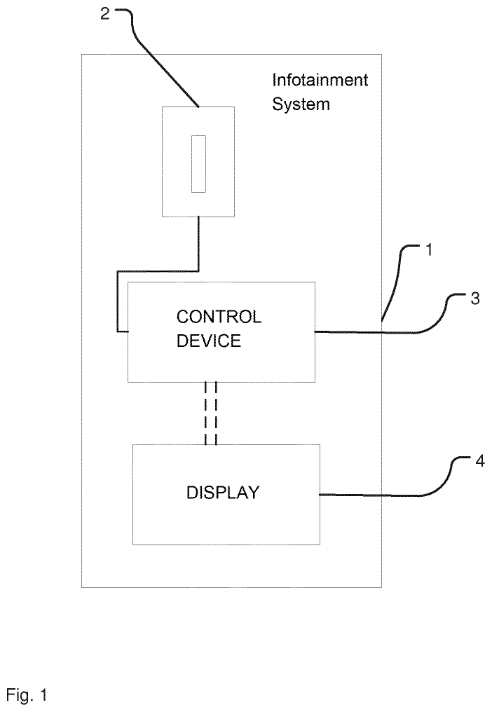

FIG. 1 shows an infotainment system 1 for a motor vehicle, which is equipped with a Bluetooth interface 2 and a control device 3 which is coupled to the Bluetooth interface 2. By means of the Bluetooth interface 2 it is possible to couple a smartphone to the infotainment system 1. Via the coupling of the smartphone it is possible to access a display 4, i.e. inputs or interrogations can be made to the display 4. If the smartphone is coupled to the infotainment system 1, appointments, calendar entries, information and messages can be displayed using the display. If the vehicle is stationary, the driver is provided with a specific (first) selection of operator control options for the display 4. This (first) selection includes, inter alia, the Bluetooth coupling. If the vehicle is moving (driving mode), the number of operator control options (second selection) is reduced, e.g. the Bluetooth coupling of the smartphone can then no longer be implemented. If a driver assistance system, e.g. a lane keeping assistant, is activated during driving, the second selection of the operator control options is extended with specific operator control options. For example, the Bluetooth coupling of the smartphone is then available again.

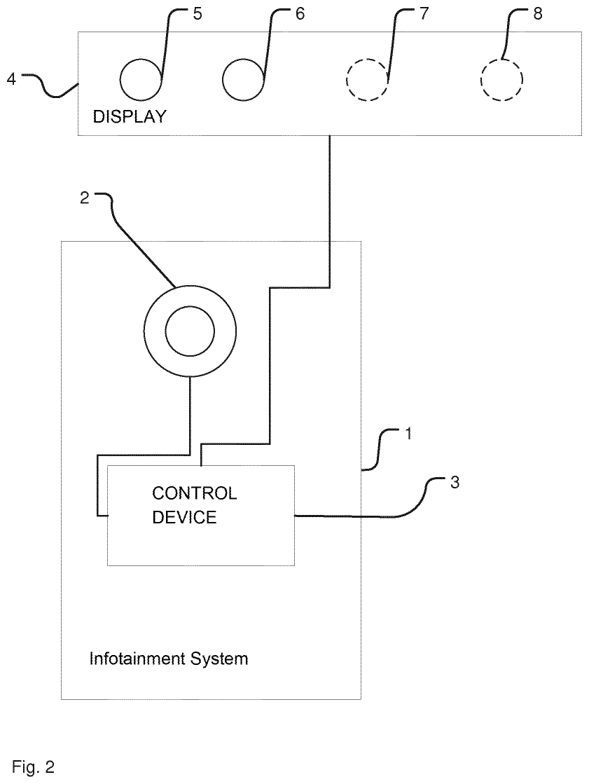

FIG. 2 shows a further variant of an infotainment system 1 for a motor vehicle such as has already been described in FIG. 1. The display 4, which is not a component of the infotainment system 1 here, is operated by means of a control device 3 via a push and turn switch 2. During a non-automated or non-autonomous driving mode, the driver is provided with only two operator control options 5 and 6, e.g. the navigation system and the telephone function, while two further operator control options 7 and 8, e.g. e-mail processing and access to the operator control instruction, are disabled. If an automated driving mode is then assumed, e.g. if the car is parked by the parking assistant or if the steering and lane keeping assistant takes over the control of the vehicle, the driver is then also provided with the further operator control options 7 and 8 and he can access these functions. If the vehicle is stationary, all of the operator control options 5 to 8 can be accessed.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An operator control device for a motor vehicle having a driving mode and a stationary mode, the operator control device comprising:
an operator control part by which an operator control process is carried out for a communication device; and
a control device which is coupled to the operator control part and is configured to provide at least a driver of the motor vehicle with a first selection of operator control options for the communication device in the stationary mode, and with a second selection of operator control options for the communication device in the driving mode,
wherein the operator control options of the second selection are selected as a function of a degree of automation of the driving mode.

2. The operator control device as claimed in claim 1, wherein
the number of operator control options of the second selection is larger the higher the degree of automation of the driving mode.

3. The operator control device as claimed in claim 2, wherein
the second selection comprises all operator control options of the first selection if a fully automated or driverless driving mode is present.

4. The operator control device as claimed in claim 1, wherein
the operator control part is assigned a proximity sensor system by which access of the driver or of a passenger to the operator control part is sensed, and the control device is further configured to provide the driver and the passenger with different operator control options in the second selection as a function of access of the driver or the passenger which is sensed by the proximity sensor system.

5. The operator control device as claimed in claim 4, wherein
the number of operator control options for the driver rises as the degree of automation of the driving mode increases.

6. The operator control device as claimed in claim 5, wherein
the operator control options for the driver are equal to the operator control options for the passenger if a fully automated or driverless driving mode is present.

7. The operator control device as claimed in claim 4, wherein
the proximity sensor system is assigned a sensing unit which is configured to check the sensed access for plausibility.

8. The operator control device as claimed in claim 1, wherein
the second selection comprises at least one operator control option which is not contained in the first selection.

9. The operator control device as claimed in claim 8, wherein
the second selection comprises at least one operator control option of the first selection.

10. The operator control device as claimed in claim 1, wherein
the second selection comprises at least one operator control option of the first selection.

11. A method for operating an operator control device for a motor vehicle having a driving mode and a stationary mode, the operator control device having an operator control part by which an operator control process is carried out for a communication device and a control device which is coupled to the operator control part and is configured to provide at least a driver of the motor vehicle with a first selection of operator control options for the communication device in the stationary mode, and with a second selection of operator control options for the communication device in the driving mode, the method comprising the acts of:
determining a degree of automation of the driving mode; and
providing at least the driver of the motor vehicle with the first selection of operator control options for the communication device in the stationary mode, and the second selection of operator control options for the communication device in the driving mode, wherein the operator control options of the second selection are selected as a function of the degree of automation of the driving mode.

12. The operator control device as claimed in claim 11, wherein
the number of operator control options of the second selection is larger the higher the degree of automation of the driving mode.

13. The operator control device as claimed in claim 12, wherein
the second selection comprises all operator control options of the first selection if a fully automated or driverless driving mode is present.

14. The operator control device as claimed in claim 11, wherein
the operator control part is assigned a proximity sensor system by which access of the driver or of a passenger to the operator control part is sensed, and the control device is further configured to provide the driver and the passenger with different operator control options in the second selection as a function of access of the driver or the passenger which is sensed by the proximity sensor system.

15. The operator control device as claimed in claim 14, wherein
the number of operator control options for the driver rises as the degree of automation of the driving mode increases.

16. The operator control device as claimed in claim 15, wherein
the operator control options for the driver are equal to the operator control options for the passenger if a fully automated or driverless driving mode is present.

17. The operator control device as claimed in claim 14, wherein
the proximity sensor system is assigned a sensing unit which is configured to check the sensed access for plausibility.

18. The operator control device as claimed in claim 11, wherein
the second selection comprises at least one operator control option which is not contained in the first selection.

19. The operator control device as claimed in claim 18, wherein
the second selection comprises at least one operator control option of the first selection.

20. The operator control device as claimed in claim 11, wherein
the second selection comprises at least one operator control option of the first selection.
